(19) United States
(12) Patent Application Publication
(10) Pub. No.: US 2004/0245885 A1
(43) Pub. Date: Dec. 9, 2004

(54) Brush-holder system and driving device

(76) Inventors: Rainer Bruhn, Ingersheim (DE); Martin Jauch, Mundelsheim (DE)

Correspondence Address: Jonathan P Osha, Rosenthal & Osha, One Houston Center, Suite 2800, 1221 McKinney Street, Houston, TX, 77010, US

(21) Appl. No.: 10/491,391

(22) PCT Filed: Sep. 9, 2002
(86) PCT No.: PCT/EP02/10068

(30) Foreign Application Priority Data
Oct. 2, 2001 (DE) 101 48 705.3

(51) Int. Cl. H02K 5/24; H02K 11/00; H02K 13/00

(52) U.S. Cl. 310/239; 310/71; 310/51

(57) ABSTRACT

A brush holder system for an electrical driving device having a brush-holder plate, a central opening for receiving a collector, as well as leaf springs arranged on the brush-holder plate, including respectively a brush, carrying the brush current and pushing the brushes with a preloaded force acting in the direction of the longitudinal axis of the central opening. The brush-holder plate includes guiding means for guiding in a radial direction the brushes or the brush segments including the brushes, the spring leafs.

The invention relates to a brush holder system for an electrical drive unit, having a brush holder plate, with a central opening to accommodate a collector, with leaf springs arranged on the brush holder plate at one end and at the other end each having a brush and carrying the brush current, the leaf springs impinging on the brushes with a pre-stressing force acting in the direction of the longitudinal axis of the central opening. Viewed from the side, the leaf springs of such brush holder systems are of a regular U-shape. The free end of one leg of the U-shape has the brush, which is arranged either directly on the leaf spring or by way of a brush mount. The other free end of the U-shaped leaf spring can be advantageously inserted into the brush holder plate perpendicular thereto. Advantageously, such leaf springs can be fitted automatically. The invention furthermore relates to an electrical drive unit having a brush holder system.

A disadvantage of the known brush holder systems is that when the drive unit is in operation, that is to say with the commutator rotating, the brush springs with the brushes readily start to oscillate causing unwanted noise.

The object of the present invention therefore is to provide a brush holder system which does not have a tendency to generate noise.

According to the invention, this object is achieved in a brush holder system of the type described in that the brush holder plate has guides for guiding the brushes or the brush sections of the leaf springs having the brushes in a radial direction. The guides consequently serve to absorb the lateral forces occurring, thereby preventing the brushes or the brush sections from being able to move, particularly in the direction of rotation of the commutator. A free oscillation of the ends of the leaf springs having the brushes is thereby prevented. As a result any noise generated and emanating from the leaf springs during operation of the drive unit is reduced and ideally is completely avoided.

The guides are advantageously arranged laterally next to the respective brush or the respective brush section, so that they provide the brushes or the brush sections with lateral support. Such guides can be arranged on the brush holder plate at relatively low cost. In the case of a plastic brush holder plate they can be moulded directly on to the brush holder plate. Guides are advantageously provided laterally next to the respective brushes or brush sections, that is to say a total of two guides per brush or brush section, so that the brush or the respective brush section cannot be deflected either to one side or the other. Any oscillation of the leaf spring conducive to noise is thereby prevented.

In an advantageous embodiment of the invention the guides are designed as guide planes. In production engineering terms guide planes in the form of guide walls are inexpensive to produce. Furthermore, it is possible to ensure that a uniform coefficient of friction exists between the brush or the brush section and the guide plane.

In a further, advantageous embodiment of the invention the guide planes extend parallel to a direction running radially to the longitudinal axis of the central opening. In this case the mid-plane of the leaf springs advantageously runs through the longitudinal axis of the central opening perpendicular to the brush holder plate. The guide planes are then arranged parallel to this mid-plane and parallel to one another.

According to the invention it is also feasible for at least sections of the narrow sides of the leaf spring extending in the longitudinal direction of the leaf spring to interact with the guides. In order to reduce unwanted oscillations, the narrow sides of the leaf springs are therefore supported on the guides.

An outstanding feature of an especially preferred embodiment of the invention is that guide runners, which interact with the guides, are arranged at least on sections of the narrow sides of the leaf springs extending in the longitudinal direction of the leaf spring. Such guide runners ensure that the leaf springs and the guide runners are accurately positioned and bear securely on the guides. Furthermore the coefficients of friction between guide runners and guides can be minimised, which has a positive effect on the running properties of the drive unit.

The guide runners are advantageously arranged in the area of the brush section. At the same time the brush sections may conceivably have a guide runner on each of the opposing narrow sides. These guide runners then rest on the guides, in particular on guide planes, assigned to each of them respectively.

A particularly advantageous development results if the guide runners are integrally formed with the leaf springs. The guide runners in this case advantageously take the form of bent-off sections of the actual leaf springs.

In order to provide a large bearing surface between the guide runners and the associated guide or guide plane, at least sections of the guide runners may, according to the invention, extend parallel to the respectively assigned guides or guide planes. Such guide runners can be made by bending off corresponding sections of the leaf springs, preferably by 90°.

In a further advantageous development of the invention the guide runners are designed so that they are elastically flexible on the leaf spring. Such guide runners are suitable for absorbing or damping oscillations, so that the generation of noise can thereby be prevented.

In a further and likewise especially preferred embodiment of the invention the guide runners are pre-stressed against the guides. The brushes or the brush sections are then each supported free from play between two guides. Any lateral deflection of the sections of the leaf springs having the brushes is therefore impossible. Consequently any oscillations are prevented and unwanted noises do not occur.

In a further development of the invention the brush holder plate has retainers to hold the brush sections in a preassembly position. These retainers hold the brushes in the preassembly position against the spring force, so that a commutator, a least in sections, can be introduced into the central opening without being impeded by the brushes. The retainers in the preassembly position advantageously interact with the respective leaf spring or brush in the area of the free end face of the leaf spring. This area is suitable when the guides are arranged laterally next to the brushes or brush sections.

An advantageous development of the invention is obtained if the retainers are designed as lug or stud-like projections extending coaxially with the longitudinal axis of the central opening. This has the advantage that when fitting perpendicular to the brush plate the brushes can be fitted in the preassembly position. Slightly raising the brushes away from the brush holder plate causes the lug or stud-like projections to release the free end of the leaf spring, so that the brushes so that the brushes drop into the assembly position or the contact position with the commutator.

The stated object is further achieved by an electrical drive unit having an armature shaft, with an armature assembly having a torsionally rigid coupling to the armature shaft, with a commutator arranged so that it cannot rotate on the shaft and coupled to the armature assembly, and with a brush holder system as previously described interacting with the commutator. In such a drive unit the leaf springs are not subject to unwanted oscillations which might lead to noise in the operation of the drive unit.

Further advantageous developments and details of the invention are set forth in the following description, in which the invention is described and explained in more detail with reference to the example of an embodiment represented in the drawing, in which:

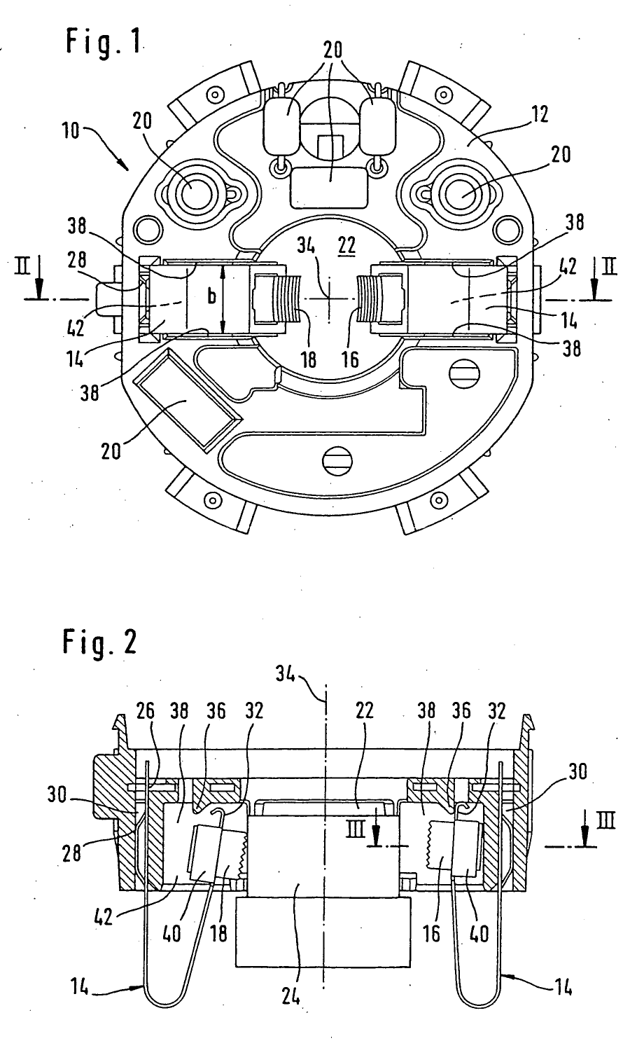

FIG. 1 shows a top view of a brush holder system according to the invention;

FIG. 2 shows a section through the brush holder system in FIG. 1 along the line II;

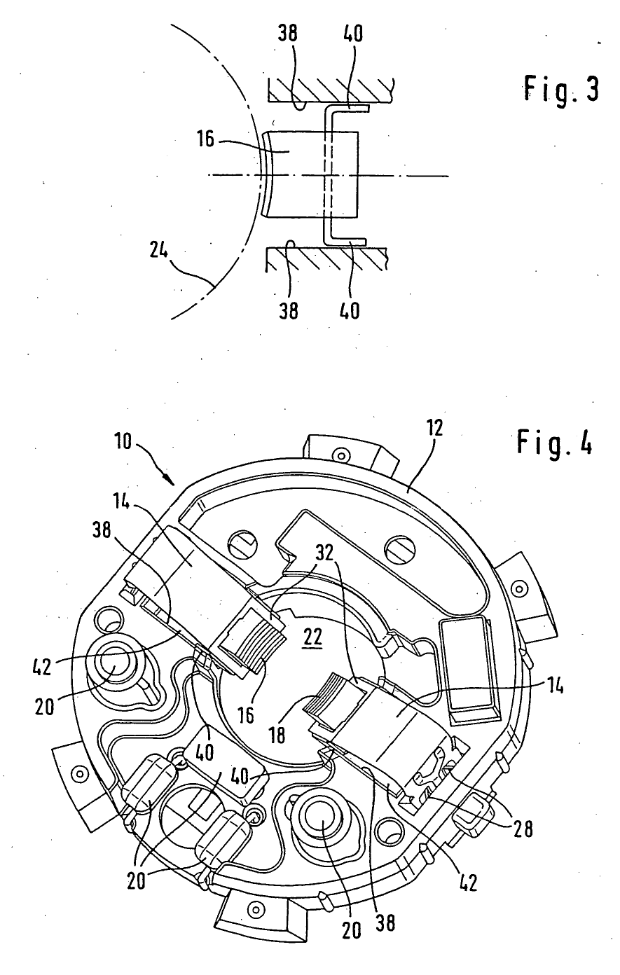

FIG. 3 shows part of a section along the line III in FIG. 2; and

FIG. 4 shows an oblique perspective view of the brush holder system in FIG. 1 from above.

The figures show a brush holder system 10 for an electrical drive unit. The brush holder system 10 comprises a brush holder plate 12 on which two brushes 16 and 18 are arranged by means of leaf springs 14. Also fitted on the brush holder plate 12 are various electronic components 20, which are partly situated in depressions provided for this purpose. The brush holder plate 12 has a central opening 22, which is intended to accommodate at least sections of a collector, which in FIG. 2 is indicated by the reference number 24.

As can clearly be seen from the section in FIG. 2, the leaf springs 14 in the longitudinal section shown are of U-shaped design. The area of the free end 26 of one leg of the U-shape is fixed to the holder plate 12. For this purpose the leaf spring has a punched recess 28, which in each case supports the leaf spring 14 in a recess 30 running perpendicular to the holder plate. To fit the leaf springs 14 to the holder plate 12, the free ends 26 of the leaf springs are inserted axially into the recesses 30. A positively interlocking and/or frictional connection based on the corresponding design form of the punched recesses 28 and the recesses 30 gives ensures that the leaf springs 14 are securely fixed to the holder plate 12. The leaf springs 14 conduct the brush current.

The free end 32 of each leaf spring 14 that does not interact with the holder plate 12 has the respective brush 16, 18. A certain pre-stressing force of the leaf springs causes them to impinge on the brushes in the direction of the longitudinal axis 34 of the central opening 22. This pre-stressing force ensures that with the brush holder system 10 in the assembled state the brushes 16, 18 are pressed against the collector 24.

FIG. 2 shows the brush 18 in the final assembled state in which a pre-stressing force presses it against the collector 24. By contrast, the brush 16 is shown in a pre-assembled position in which it is held by a retainer in the form of a lug-like projection extending coaxially with the longitudinal axis 34. The projection 36 in this case grips behind the end section of the free end 32 of the leaf spring 14.

In order to prevent any oscillation of the free ends of the leaf springs 14 having the brushes 16 and 18 in or counter to the direction of rotation of the collector 24 when the fitted brush holder system is in operation, the brush holder plate has guides to guide the brushes or the brush sections 32 of the leaf springs 14 having the brushes in a radial direction. The guides are in this case designed as guide planes 38 arranged on the holder plate 12 perpendicular to the plane of the holder plate 12. Two guide planes 38 running parallel to one another, which are arranged laterally next to the respective brush 16, 18 or the respective brush section 32, are provided for each leaf spring 14. The leaf springs 14 or the brush sections 22 are thereby laterally supported against the guide planes 38. In the plan view in FIG. 1, the interval between each two associated guide planes 38 is slightly greater than the width b of the leaf springs.

In order to ensure a defined interaction between the leaf spring section 32 and the guide planes 38, the narrow sides of the leaf springs 14 or the brush sections 32 extending in the longitudinal direction of the leaf spring have guide runners 40. The guide runners 40, which are arranged to right and left of the brushes 16, 18, are integrally formed with the leaf spring 14. The section forming the respective guide runner 40 is bent off by approximately 90° and extends parallel to each of the assigned guide planes 38, as can clearly be seen from FIG. 3. This results in a relatively large bearing surface between guide runner 40 and associated guide plane 38, so that the bearing forces are kept relatively small.

The guide runners 40 may advantageously impinge on the guide planes 38 under a slight pre-stressing force. This has the advantage that it provides radial guidance of the brushes 16, 18 arranged on the leaf springs 14 free from play. At the same time the guide runners 40 can be arranged on the leaf springs 14 so that they are elastically flexible.

The holder plate 12 is made in one piece from plastic. The guide planes 38 are formed as walls of recesses 42 that in plan view are of rectangular shape. Such recesses are very easy and inexpensive to produce.

The brush holder system 10 described has the particular advantage that the brush sections 32 of the leaf springs 14 having the brushes 16, 18 are oscillation-damped. This serves, in particular, to prevent high-frequency oscillations and prevents unwanted noise when a drive unit comprising the brush holder system 10 is in operation. Furthermore, the lateral guide face of the brush sections 32 is enlarged, thereby preventing the leaf springs 14 from tilting. In this way secure, radial guidance of the brushes 16, 18 can be ensured regardless of external temperatures.

In addition, any lateral misalignment of the contact point of the respective brush 16, 18 on the commutator 24 is prevented. This leads to quiet, uniform running of the drive unit.

A further advantage of the invention is that the secure, radial guiding of the leaf springs 14 serves to prevent unwanted deformation of the leaf springs 14 during assembly of the brush holder system 10 or during operation of a corresponding electrical drive unit. The chosen thickness of the leaf springs 14 can therefore be kept correspondingly small. A low spring force or a flat spring characteristic is sufficient to ensure a reliable contact pressure of the brushes 16, 18 against the commutator 24.

All features represented in the description, the following claims and the drawing may be essential for the invention both singly and in any combination with one another.

What is claimed is:

1. A brush holder system for an electrical drive unit, having a brush holder plate, with a central opening to accommodate a collector, with leaf springs arranged on the brush holder plate at one end and at the other end each having a brush and carrying the brush current, the leaf springs impinging on the brushes with a pre-stressing force acting in the direction of the longitudinal axis of the central opening, characterised in that the brush holder plate has guides for guiding the brushes or the brush sections of the leaf springs having the brushes in a radial direction.

2. The brush holder system according to claim 1, characterized in that the guides are arranged laterally next to the respective brush or the respective brush section, so that they provide the respective brush or the respective brush section with lateral support.

3. The brush holder system according to claim 1, characterized in that the guides are designed as guide planes.

4. The brush holder system according to claim 1, characterized in that the guide planes extend parallel to a direction running radially to the longitudinal axis of the central opening.

5. The brush holder system according to claim 1, characterized in that at least sections of the narrow sides of the leaf springs extending in the longitudinal direction of the leaf spring interact with the guides.

6. The brush holder system according to claim 1, characterized in that a guide runner, which interacts with the respective guide, is arranged at least on sections of at least one narrow side of the respective leaf spring extending in the longitudinal direction of the leaf spring.

7. The brush holder system according to claim 6, characterized in that the guide runners are in each case arranged in the area of the brush section.

8. The brush holder system according to claim 6, characterized in that the brush sections each have a guide runner on the opposing narrow sides.

9. The brush holder system according to claim 6, characterized in that the guide runners are integrally formed with the respective leaf spring.

10. The brush holder system according to claim 6, characterized in that the guide runners, at least in sections, extend parallel to the respectively assigned guides or guide planes.

11. The brush holder system according to claim 6, characterized in that the guide runners are arranged so that they are elastically flexible on the leaf spring.

12. The brush holder system according to claim 6, characterized in that the guide runners under a pre-stressing force impinge against the guides.

13. The brush holder system according to claim 1, characterized in that the brush holder plate has retainers for holding the brush sections in a preassembly position.

14. The brush holder system according to claim 13, characterized in that the retainers in the preassembly position interact with the respective leaf spring or brush in the area of the free end face of the leaf spring.

15. The brush holder system according to claim 13, characterized in that the retainers are designed as lug or stud-like projections extending coaxially with the longitudinal axis of the central opening.

16. An electrical drive unit having an armature shaft, with an armature assembly having a torsionally rigid coupling to the armature shaft, with a commutator arranged so that it cannot rotate on the shaft and coupled to the armature assembly, and with a brush holder system interacting with the commutator, wherein the brush holder system comprises a brush holder plate, with a central opening to accommodate a collector, with leaf springs arranged on the brush holder plate at one end and at the other end each having a brush and carrying the brush current, the leaf springs impinging on the brushes with a pre-stressing force acting in the direction of the longitudinal axis of the central opening, characterised in that the brush holder plate has guides for guiding the brushes or the brush sections of the leaf springs having the brushes in a radial direction according to any one of the preceding claims interacting with the commutator.

17. The brush holder system according to claim 2, characterized in that the guides are designed as guide planes.

18. The brush holder system according to claim 3, characterized in that the guide planes extend parallel to a direction running radially to the longitudinal axis of the central opening.

19. The brush holder system according to claim 7, characterized in that the brush sections each have a guide runner on the opposing narrow sides.

20. The brush holder system according to claim 7, characterized in that the guide runners are integrally formed with the respective leaf spring.
